(19) United States
(12) Patent Application Publication
(10) Pub. No.: US 2006/0176173 A1
(43) Pub. Date: Aug. 10, 2006

(54) Override Transmitter-S.B.

(76) Inventor: Nicholas Allan Goldstein, Effingham, IL (US)

Correspondence Address: Nicholas Goldstein, 601 West Rickelman, Effingham, IL, 62401, US

(21) Appl. No.: 10/906,130

(22) Filed: Feb. 3, 2005

(51) Int. Cl. G08B 1/08

(52) U.S. Cl. 340/538.11

(57) ABSTRACT

An emergency transmitter apparatus designed to warn a motorist when an active emergency vehicle is in the area and/or of a hazardous condition in the area. The emergency transmitter apparatus can also be used by itself or with multiple emergency transmitters of similar type to set up an emergency warning perimeter. The apparatus transmits signals synchronized with those of other transmitters of similar type. A combination of signal generating and mixing will result in the transmission of frequencies that cover all of the frequencies that a motorist would typically be tuned to. The operator of the emergency transmitting apparatus will choose to transmit any one of numerous audio signals or detailed voice warnings. The operator of the emergency transmitter may also transmit a live audio warning by use of an input device. The emergency transmitter has a variable transmission power level output to allow adjustment for varying emergency and location factors.

### REFERENCES CITED

This is a list of references for this patent:

| | | | |
|---|---|---|---|
| 3673560 | June, 1972 | Barsh et al. | 340/901 |
| 3760349 | September, 1973 | Keister et al. | 340/902 |
| 3859623 | January, 1975 | Koehler | 340/902 |
| 3864674 | February, 1975 | Worsham et al. | 340/902 |
| 3873963 | March, 1975 | Neal et al. | 340/902 |
| 3949300 | April, 1976 | Sadler | 455/1 |
| 4100529 | July, 1978 | Evans | 340/901 |
| 4238778 | December, 1980 | Ohsumi | 340/903 |
| 4241326 | December, 1980 | Odom | 340/333 |
| 4296496 | October, 1981 | Sadler | 455/1 |
| 4403208 | September, 1983 | Hodgson et al. | 340/902 |
| 4443790 | April, 1984 | Bishop | 340/539 |
| 4764978 | August, 1988 | Argo et al. | 455/1 |
| 5278553 | January, 1994 | Cornett et al. | 340/902 |
| 5303259 | April, 1994 | Loveall | 375/135 |
| 5572201 | November, 1996 | Graham et al. | 340/902 |
| 5635921 | June, 1997 | Maxwell et al. | 340/902 |
| 5757284 | May, 1998 | Trizzino et al. | 340/902 |
| 5808560 | September, 1998 | Mulanax | 340/902 |
| 5825304 | October, 1998 | Marin | 340/903 |
| 5889475 | March, 1999 | Klosinski et al. | 340/902 |
| 5917430 | June, 1999 | Greneker et al. | 340/905 |
| 5926112 | July, 1999 | Hartzell | 340/902 |
| 6087961 | July, 2000 | Markow | 340/902 |
| 6160493 | December, 2000 | Smith | 340/902 |
| 6222461 | April, 2001 | Hazen | 340/901 |
| 6252521 | June, 2001 | Griffin et al. | 340/903 |
| 6362749 | March, 2002 | Brill | 340/902 |
| 6463273 | October, 2002 | Day | 455/404.1 |

### PRIOR ART

Audio warning systems such as sirens are becoming less effective because of enhanced motor vehicle soundproofing. An added complication to the sound problem is that many motorists listen to the radio when driving. Also, in many urban areas, visual clutter has reduced the effectiveness of emergency flashers. It is because of this that motorists are not warned until the emergency vehicle is very close so that its siren may be heard through the sound resistant vehicle, or close enough and in visual range such that the flashing lights from the emergency vehicle can be seen.

Even though there has been many similar ideas patented, all of them would be either too expensive to implement or the concept patented contains large flaws. One approach that has been numerously patented is the idea of putting a receiver/detection system in motorists' vehicles. U.S. Pat. No. 3,859,623, issued to Koehler, suggests a microphone and filter system be installed in every motor vehicle that could detect low audio sirens from outside the vehicle and warn the driver inside. Similar patents like: U.S. Pat. No. 5,278,553, issued to Cornett et al., U.S. Pat. No. 3,873,963, issued to Neal et al., U.S. Pat. No. 4,403,208, issued to Hodgson et al., U.S. Pat. No. 4,241,326, issued to Odom, U.S. Pat. No. 4,238,778, issued to Ohsumi, U.S. Pat. No. 3,760,349, issued to Keister et al., U.S. Pat. No. 3,673,560, issued to Barsh et al., and U.S. Pat. No. 3,710,313, issued to Kimball et al., all would require the installation of additional equipment into motorists' vehicles. The cost and trouble of the installation and the unit to motorists would dissuade them from purchasing it or taking the time to install it even if the device was given to them.

The other approach is the one I took, by having a transmitter, put into emergency vehicles, that could override the radio station that the motorist is listening to and deliver a warning signal or message. One of the things claimed by me that sets this patent apart is that the carrier frequencies and intelligence signals of one transmitter be synchronized with the carrier frequencies and intelligence signals of the other transmitters in the area by means of an internal clock signal. In the likely event that a motorist is in range of more than one transmitter without synchronization, then the unsynchronized transmitters would both come in over the radio resulting in static and an unrecognizable message coming through the radio which would draw the motorist's attention away from the road to the radio causing the motorists to pay less attention to his/her surroundings during the emergency/hazardous situation. U.S. Pat. No. 5,636,921, issued to Maxwell et al., is an example of a device that might work if only one of its described devices were transmitting at once. However, if two are transmitting at once, the signals or messages received would not start and end together resulting in the previously mentioned problems.

One problem with all of the referenced prior artwork is that there is no mention of transmitting on satellite radio frequencies. With subscriptions to satellite radios numbering in the millions, and satellite radio companies making deals with car companies, there is a good possibility that a motorist will be listening to a satellite radio receiver while driving. Therefore, if an emergency radio transmitter was to be made it must include means of transmitting to or into satellite radios.

### SUMMARY OF THE INVENTION

The device I have invented is an emergency transmitter apparatus designed to warn civilian motorists when there is a hazardous situation and/or an active emergency vehicle such as a police, ambulance, or fire truck in the area. The emergency transmitter apparatus will have the ability to transmit a siren or audio message through the radio, overriding the existing radio station that the motorist is tuned to, making the sound resistant qualities of the vehicle and the radio noise irrelevant.

The driver of the emergency vehicle will turn the emergency transmitter on and adjust the power level in the event of an emergency. The reason for this is to provide minimal inconvenience to anyone in the area that may not need to be warned of an emergency. The power levels will be preset for certain ranges, (i.e.) ⅛, ¼, ½, ¾, and 1 mile ranges. The position that the emergency vehicle operator turns the power knob to will be dependant on the degree of emergency as well as the area (rural or urban) that the emergency vehicle is in. For example, a simple car crash where both motorists have been reported to have only minor injuries would only warrant the lowest level of transmission power; on the other side however, a burning building with people inside, a severe car crash, an armed robbery, or even a terrorist attack would all justify transmitting on full power because inconveniencing a few motorists is irrelevant when lives are in the balance. Another reason for an adjustable power level is for urban and rural differences. Driving through streets in town involves slowing down for turning and a reasonable amount of speed caution so therefore, the amount of distance in which one would need to transmit to give ample warning is less than in a rural, highway, or interstate setting where the emergency vehicle will be going at greater speeds requiring the motorists to be warned sooner.

A secondary option of the emergency transmitter is that it can be removed from the dashboard of the emergency vehicle and used to set up a “transmit perimeter.” In the event that emergency personnel will be at the scene for an extended period of time, multiple emergency transmitters can be set up in a perimeter fashion to warn motorists in all directions by transmitting one of several audio messages or sirens. Some of the audio messages could say but are not limited to: “Warning, traffic complications ahead”, or “Warning severe weather, seek shelter”, or “This is a police emergency, pull over immediately”, or “Warning, there is an emergency situation in the area”, or even a message about a severe fire emergency.

The emergency transmitter apparatus will generate three separate electronic base signals, one in each of the A.M., C.B., and F.M. bands. These signals will be mixed with signals whose frequencies are multiples of the bandwidth for the corresponding band. The result will be one base frequency and a plurality of sidebands for each band, covering all of the frequencies in each band that corresponding receivers may be tuned to. For example, creating a base signal of 1120 kiloHertz and mixing that signal with signals that are multiples of the bandwidth for the A.M. band (10 kHz) would result in sidebands that were 10 kHz apart and would be equal in frequency to each of the tunable frequencies in the A.M. band. The same procedure will be done for transmitting on the F.M. and C.B. bands with the difference being the values of the frequencies that are multiples of the bandwidth for that particular band. The generated electronic signals will be modulated according to the way in which information is transmitted in the corresponding band. The electronic signals will be amplified and transmitted accordingly.

The emergency transmitter apparatus will also generate electronic signals with frequencies equal to consumer satellite radio frequencies. It will then modulate these signals with digital information, amplify them and transmit them accordingly.

The emergency transmitter apparatus will also receive a radio signal that it will use to set an internal clock apparatus. Other emergency transmitters of this type will receive the same signal and will set their internal clocks by it as well. The emergency transmitters will use this internal clock to synchronize their carrier frequencies and the times in which signals/messages are transmitted resulting in audio signals that don't overlap and interfere in a motorist's radio. The received signal may be, but is not limited to, GPS signals, an Atomic Clock signal, or a signal from a local transmitter.

What is claimed is:

1. An emergency transmitting apparatus for transmitting a signal during a hazardous or emergency situation on multiple frequencies simultaneously to radio frequency receivers in nearby motorists' vehicles, the emergency radio transmission apparatus comprising:
a) a method for generating electronic signals,
b) a method for modulating the generated electronic signals,
c) a method for receiving electronic input,
d) a method for transmitting modulated signals.

2. The emergency radio transmission apparatus from claim 1 wherein said electronic signal generating method further comprises generating electronic carrier signals equal in frequency to the radio frequencies of standard consumer satellite radio frequencies.

3. The emergency radio transmission apparatus from claim 1 wherein said method for mixing generated electronic signals further comprises mixing three base signals, one from each of the A.M., F.M., and C.B. bands, with other generated electronic signals that are multiples of the bandwidth for a corresponding band to produce a plurality of sideband signals equal to the frequencies of all standard A.M., F.M., and C.B. frequencies.

4. The said method of receiving electronic input from claim 1 further comprises:
a) A method of receiving electronic input from electronic memory devices,
b) A method of receiving electronic input by means of a microphone.

5. A method for receiving and using a radio frequency signal, the method comprising the steps of:
a) A method for receiving said radio frequency signal,
b) A method for using said radio frequency signal to set an internal electronic clock signal.

6. A method for using said internal clock signal from claim 5 to synchronize said carrier signal and said electronic input signal in said emergency radio transmitter device to corresponding signals in similar emergency transmitter devices.

7. A system for changing the power output of said emergency transmitting apparatus, the system comprising:
a) an external apparatus for adjustment of an electronic signal,
b) an internal circuit designed to receive said electronic signal from said external adjustment apparatus,
c) a method of changing power of transmitted signal in response to received electronic signal from said external adjustment apparatus.
